(19) United States
(12) Patent Application Publication
(10) Pub. No.: US 2010/0325215 A1
(43) Pub. Date: Dec. 23, 2010

(54) MESSAGE REQUIREMENTS BASED ROUTING OF MESSAGES

(75) Inventors: Jeremy de Souza, Redmond, WA (US); Wilbert De Graaf, Bellevue, WA (US); Gregory Gourevitch, Redmond, WA (US); Victor Boctor, Redmond, WA (US); Jeffrey B. Kay, Bellevue, WA (US); Todd C. Luttinen, Redmond, WA (US); Shubhankar Sanyal, Redmond, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/487,656

(22) Filed: Jun. 19, 2009

(51) Int. Cl. G06F 15/173; G06F 15/16

(52) U.S. Cl. 709/206; 709/238

(57) ABSTRACT

Architecture for enabling messages to be routed between network servers based on message requirements related to version, capabilities, and features, for example. The message requirements designate delivery over a transport path compatible with the message requirements. The message requirements can include a particular version or other features related to different software applications that require compatibility in message handling. Routing information is maintained related to a transport server or other network transport entity compatible with the message requirements and through which the message can be routed. The message is routed to the compatible transport server for delivery to the destination while avoiding delivery to transport servers incompatible with the message requirements.

### BACKGROUND

In an enterprise computer network, multiple servers can process a single electronic message prior to delivery. Mailbox servers are used to host user mailboxes. Transport servers receive messages through the Internet and outside networks that are destined for the user mailboxes hosted on the mailbox servers. Transport servers therefore deploy policies for communicating with the mailbox servers and other transport servers.

Different message handling requirements can result in problems when version compatibility issues exists between servers, or when a message needs specific processing only available on a server that has a specific capability to offer such processing. For example, in one version a transport server can execute inbox rules, whereas in another version, the inbox rules can be executed on the mailbox server. Thus, the methods in which these two versions execute inbox rules are incompatible.

As a result of version compatibility and other capability issues, it can happen that a transport server running a newer version can only deliver messages to mailbox servers also running the newer version. Similarly, a transport server running an older version can only deliver messages to mailbox servers also running the older version.

Server applications can be made to offer backward and/or forward compatibility to other versions, with respect to message delivery. However, incorporating such compatibility can limit development of subsequent versions. It can be desirable to develop subsequent versions having new processes and methods for routing messages differently to a destination mailbox, corresponding to capabilities, message requirements, and/or an offered feature set. However, a lack of compatibility can limit communication between network components operating different versions or other capabilities, message requirements, and/or other offered feature sets.

### SUMMARY

The following presents a simplified summary in order to provide a basic understanding of some novel embodiments described herein. This summary is not an extensive overview, and it is not intended to identify key/critical elements or to delineate the scope thereof. Its sole purpose is to present some concepts in a simplified form as a prelude to the more detailed description that is presented later.

The disclosed architecture provides version and capability-based routing of messages where, instead of making different server versions forward and/or backward compatible, compatibility issues can be resolved through message routing between transport servers in a network. A mailbox server receives a message from a user mailbox and submits the message to a transport server of the same version or otherwise having the same capabilities or message requirements. If the transport server determines that the mailbox of a client is hosted on a mailbox server having incompatible message requirements, the transport server sends the message to a different transport server having message requirements compatible with the mailbox server hosting the client's mailbox. In this manner, capability-based routing avoids backward and/or forward compatibility for protocols used between transport servers and mailbox servers.

To the accomplishment of the foregoing and related ends, certain illustrative aspects are described herein in connection with the following description and the annexed drawings. These aspects are indicative of the various ways in which the principles disclosed herein can be practiced and all aspects and equivalents thereof are intended to be within the scope of the claimed subject matter. Other advantages and novel features will become apparent from the following detailed description when considered in conjunction with the drawings.

### BRIEF DESCRIPTION OF THE DRAWINGS

FIG. 1 illustrates a computer-implemented message system in accordance with the disclosed architecture.

FIG. 2 illustrates types of message requirements used with the message system.

FIG. 3 illustrates an alternative embodiment of a message system that includes additional entities for message referral and advertising message requirements.

FIG. 4 illustrates an alternative embodiment of a message system.

FIG. 5 illustrates an alternative embodiment of a message system that includes additional entities for message routing functionality.

FIG. 6 illustrates a network implementation for routing messages based on message requirements.

FIG. 7 illustrates a method of message requirements based message routing.

FIG. 8 illustrates additional aspects of the method of capabilities-based message routing.

FIG. 9 illustrates a block diagram of a computing system operable to provide message routing in accordance with the disclosed architecture.

FIG. 10 illustrates an exemplary computing environment operable to provide message routing according to message requirements.

### DETAILED DESCRIPTION

The disclosed architecture enables messages to be routed between network servers based on version and/or capabilities. When a mailbox server submits a message for delivery to a destination, the message includes message requirements that designate delivery over a transport path compatible with the message requirements. The message requirements can include a particular version or other capabilities or features related to different software applications that require compatibility in message handling. Routing information is maintained related to a transport server or other network transport entity compatible with the message requirements and through which the message can be routed. The message is routed to the compatible transport server for delivery to the destination while avoiding delivery to transport servers incompatible with the message requirements.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives falling within the spirit and scope of the claimed subject matter.

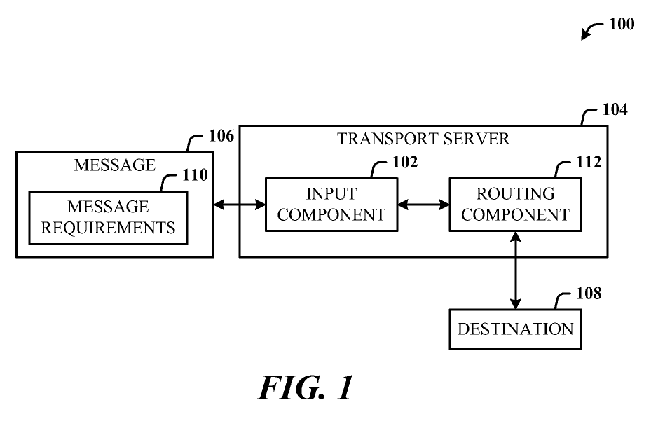

FIG. 1 illustrates a computer-implemented message system 100 in accordance with the disclosed architecture. An input component 102 of a transport server 104 is provided for receiving a message 106 submitted for delivery to a compatible destination 108. The message 106 includes message requirements 110 that designate delivery over a compatible transport path. A routing component 112 of the transport server 104 is provided for routing the message 106 over the compatible transport path to the destination 108 according to the message requirements 110.

The message 106 submitted to the transport server 104 to the input component 102 is then sent out via the routing component 112. The compatible destination 108 of the routing component 112 can be the next node, which can be another transport server that meets the message requirements 110. Alternatively, the destination 108 can be a mailbox server to which the message 106 can be delivered to a client mailbox.

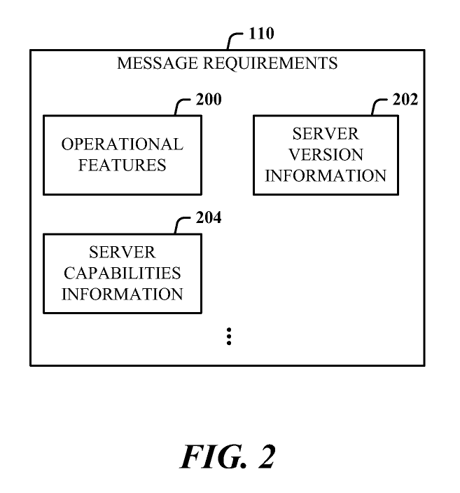

FIG. 2 illustrates types of message requirements 110 used with the message system. The message requirements 110 can include operational features 200, such as functional processing capabilities, and dynamic capacity capabilities. The message 106 is routed over a transport path (e.g., servers and other network components) having compatible operational features. The message requirements 110 can also include server version information 202, such as information defining a specific version of a server software application, and relevant modules or subcomponents that impact the capabilities and compatibility with another server version. The message 106 is then routed over a transport path having compatible server versions.

As illustrated in FIG. 2, the message requirements 110 can also include server capabilities information 204, such as hardware or software capabilities associated with the transport server 104 and/or a mailbox server. The message 106 is routed over a transport path having compatible server capabilities. The message requirements 110 can further include any other capabilities or features related to different software applications, versions, configurations, add-on modules, and/or plug-ins that require compatibility or otherwise impact performance of message handling.

The message requirements 110 can relate to determining whether a server can process a certain type of functionality, and whether a particular operation or message 106 can be processed on a specific server or forwarded to a different server that is more aligned with the capabilities needed to perform a particular process. The message requirements 110 can relate to interoperability and can include a supported protocol that interoperates between servers. The message requirements 110 can include inbox rules, in the event of applications or versions in which inbox rules are executed on a mailbox server, and different applications or versions in which the inbox rules are executed on the transport server 104. As described herein, the message requirements 110 can include different capabilities within a particular application and/or version, such as differences resulting from add-on modules, plug-ins, or configuration.

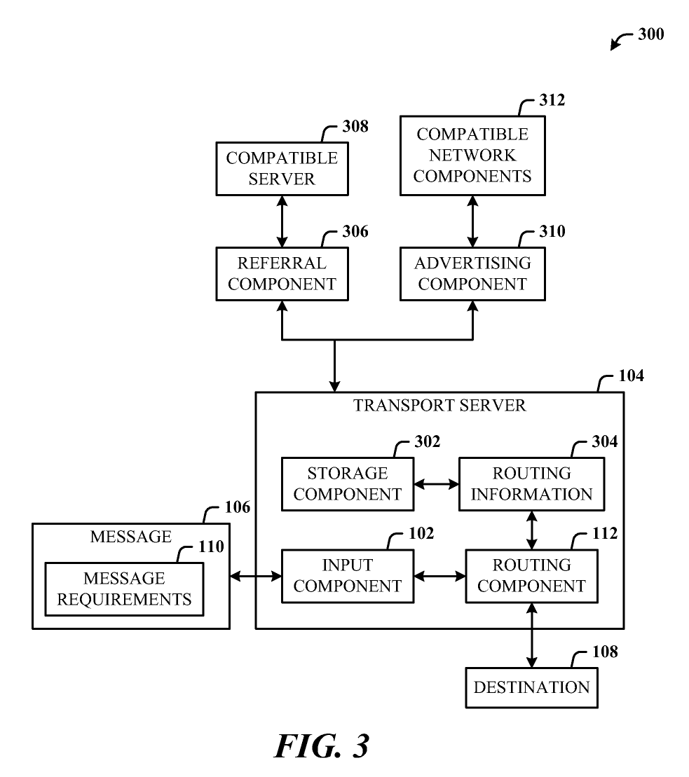

FIG. 3 illustrates an alternative embodiment of a message system 300 that includes additional entities for message referral and advertising capabilities to handle message requirements. A storage component 302 (e.g., routing tables) is provided for maintaining routing information 304 related to transport servers via which the message 106 can be routed. The routing information 304 maintains information of servers in a network to assist in efficiently routing a message 106 to the intended destination 108. The routing information 304 provides the basis for locating a server having the version or capabilities indicated in the message requirements 110. The storage component 302 can identify a set of processing operations for the message 106 and locate a server in the routing information 304 that has the indicated capabilities.

FIG. 3 also illustrates a referral component 306 for referring the message to a compatible server 308 associated with the message requirements 110. The transport server 104 or another network server or component can be offered a message for which the server does not have compatible capabilities for supporting the message requirements 110. The referral component 306 provides a referral to another server known to have compatible capabilities. In this way, messages are redirected based on message requirements 110 and/or other capability criteria. The referral component 306 can record (e.g., store, cache) destinations having specific capabilities and utilize that information for future referrals when messages are encountered needing certain capabilities.

FIG. 3 also illustrates an advertising component 310 for advertising capabilities to handle the message requirements 110 to compatible network components 312. Rather than looking up a compatible component in the routing information 304, a server or other network component can advertise its capabilities to the compatible network components 312. The advertising component 310 is especially useful across organizations to other related enterprise networks. Alternatively, the advertising component 310 can be a DNS (domain name server) that advertises certain capabilities for all servers within an enterprise, or a certain set of servers having certain capabilities.

The advertising component 310 can also incorporate referral as part of the advertisement. In addition to advertising capabilities to handle message requirements 110 of a particular server or network, components having other capabilities can be included in the advertisement. In this way, network servers and components can be directed where to find certain capabilities.

The advertising component 310 can be implemented as a peer-to-peer model in which servers participating in a network communicate with each other and engage in backend communications where the servers share capabilities with each other. The entire set of capabilities of the network is exchanged so servers can select the correct places to send messages. In this way, the advertising component 310 can thus identify message requirements 110 in a manner that can be employed to work outside an organization.

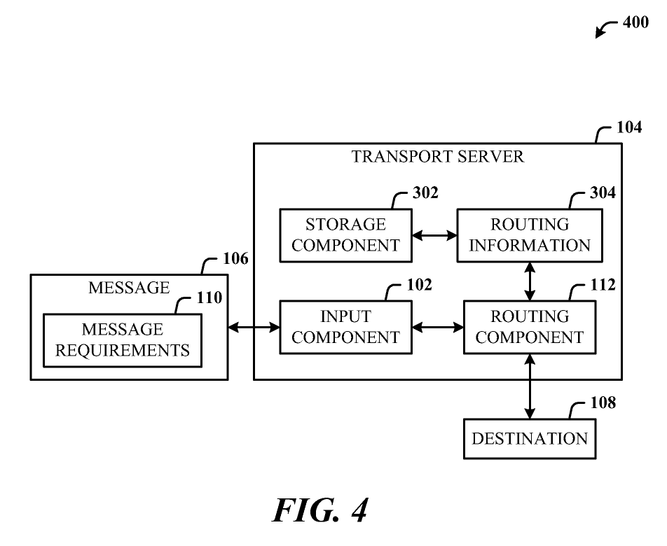

FIG. 4 illustrates an alternative embodiment of a message system 400. The input component 102 receives the submitted message 106 for delivery to the destination 108. The message 106 has message requirements 110 that designate delivery over a transport path compatible with the message requirements 110. The storage component 302 maintains the routing information 304 related to a network transport entity compatible with the message requirements 110 and via which the message can be routed. The routing component 112 routes the message 106 to the compatible network transport entity for delivery to the destination 108 while avoiding delivery to network transport entities incompatible with the message requirements.

As described herein, the routing component 112 routes the message 106 to a final destination with a short number of hops. Rather than route and reroute the message 106 to every server in the network until a compatible server is located, the routing component 112 reduces the network traffic by identifying and routing the message 106 to the compatible network transport entity along a route, thereby improving performance and efficiency.

As illustrated in FIG. 4, the message requirements 110 can include version information (as in FIG. 2) and the message 106 can be routed only to a network transport entity (or entities) having the same version information. The message requirements 110 can relate to software features (including the operational features 200 of FIG. 2) so that the message can be routed only to network entities having the same software features.

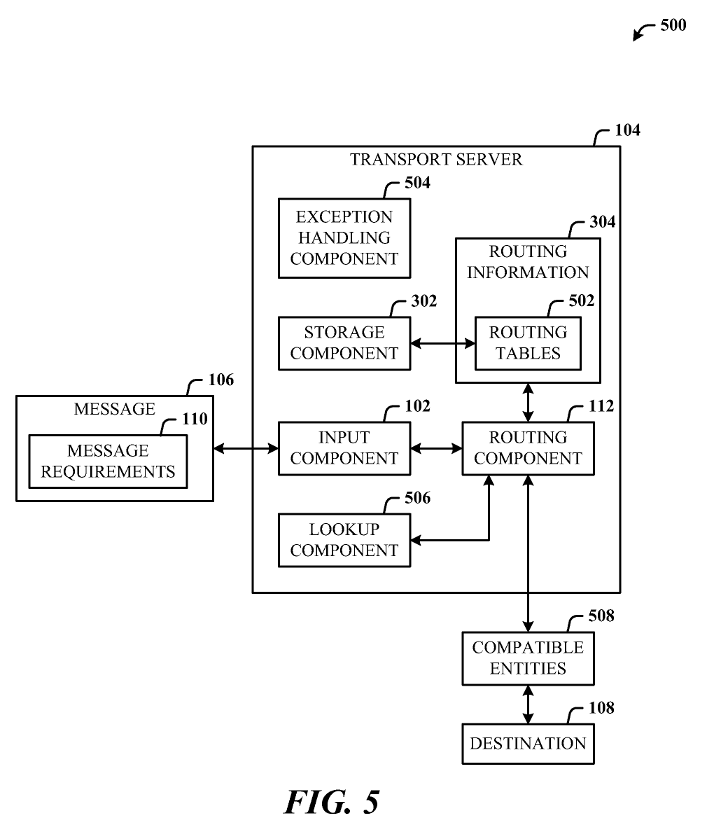

FIG. 5 illustrates an alternative embodiment of a message system 500 that includes additional entities for message routing functionality. The routing information 304 includes routing tables 502 for maintaining transport server version, features, and capabilities information and/or destination server version, features, and capabilities information. However, it can be assumed that only compatible transport servers interface to similarly compatible mailbox servers, and thus, the routing tables 502 only maintain transport server information. The routing tables 502 thereby allow the transport of the message 106 to the next compatible network component on a route to the destination mailbox server.

The routing tables 502 are used to maintain up-to-date listings of transport servers in the enterprise and/or local network segment for each version, features, and/or capabilities. It is to be appreciated that a network segment (also referred to as a site) can be an arrangement of connected computers implemented as a network directory site, a collection of subnets, and/or a network routing group (e.g., network segment implementations can include an Active Directory™ site or a Microsoft Exchange™ Routing Group, for example, both products of Microsoft Corporation). The routing tables 502 can contain information such as server versions to perform capabilities-based routing. If a message is not routable, the message can be marked “unreachable” for a network administrator to resolve the routing issue.

As illustrated in FIG. 5, an exception handling component 504 detects and generates an exception when delivery is unattainable to the destination or a next hop. It can occur that messages improperly arrive at servers that do not have the compatible capabilities, for example. While attempting to deliver the messages, an exception occurs if the mailbox is not the same version as assumed. For example, an exception can occur if a particular server has recently been upgraded to a newer version than indicated in a routing table, and a message from an older version is inadvertently routed.

As illustrated in FIG. 5, a lookup component 506 is provided to locate available compatible network transport entities 508 in the routing tables 502 through which the message 106 can be routed. The lookup component 506 searches for available servers to deliver the message. Upon finding an available compatible server, the message 106 sent to the server found by the lookup component 506.

As described herein, transport servers of all versions and other capabilities can communicate with each other through a standard protocol, such as SMTP. When a mailbox server receives a message from a sender, the message is submitted by the mailbox server to a transport server having the same version or otherwise having the same capabilities. This submission can be performed using a non-standard protocol that can change between different versions of the software. If the transport server determines that the mailbox of a recipient is hosted on a mailbox server having incompatible capabilities, the transport server can employ a more universally recognized and utilized protocol such as SMTP to submit the message to another transport server having version and/or other capabilities compatible with the mailbox server hosting the mailbox of the recipient. Upon receipt of the message, the other transport server attempts to deliver the message to the mailbox which was thought to be compatible by the original transport server.

In the event the second transport server discovers that the message cannot be delivered, because of inconsistent routing information for example, the second transport server will defer the message to be retried later, when routing information might have been resolved. If the issue is not resolved within a certain timeout period, the message can result in a non-delivery report to the original sender.

Capability-based routing avoids the need for the transport servers and mailbox servers to be backward compatible with protocols. For example, features such as inbox rules do not need to consider forward and backward compatibility. For example, in an operational network an administrator can introduce experimental features without impacting the existing production services. Experimental features can include having pilot users hosted on a mailbox with the experimental features and adding a compatible transport server. All the traffic for the mailboxes of these pilot users is only routed through a single transport server having a known protocol.

A message that has been flagged as needing a specific set of experimental features can be inspected by a transport server. If the capabilities cannot be provided, the transport server determines that another server can offer the capabilities. The transport server can then route the message, with or without any processing, to a server that does provide the indicated or requested capabilities for processing the message. Thus, capabilities-based routing is useful for introducing new services more effectively and efficiently without impacting existing services.

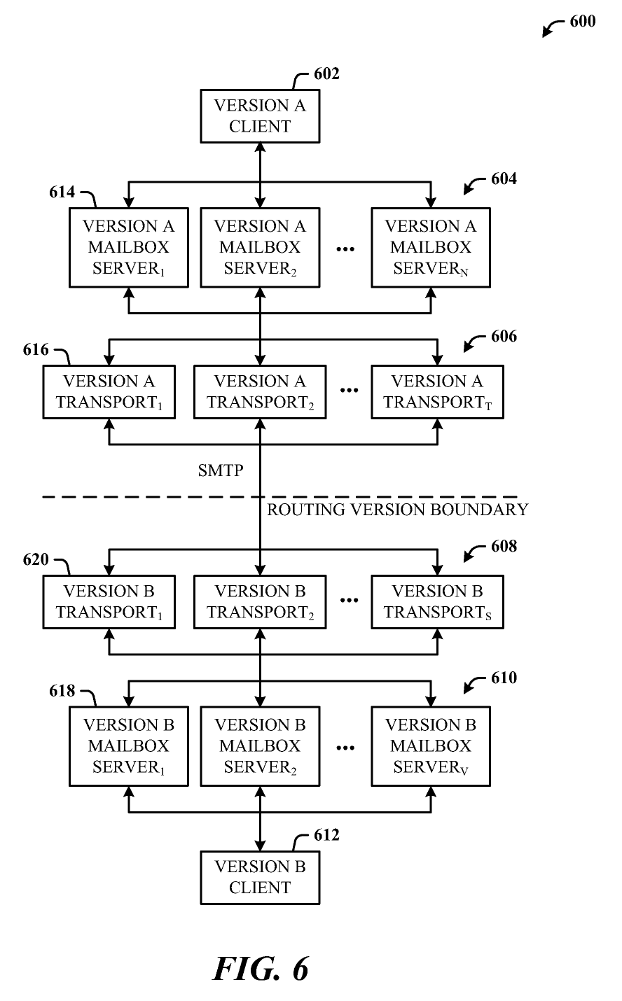

FIG. 6 illustrates a network implementation 600 for routing messages based on version message requirements. A “Version A” client 602 communicates with one of multiple “Version A” mailbox servers 604, which in turn communicate over a network with one of multiple “Version A” transport servers 606. The “Version A” transport servers 606 communicate with “Version B” transport servers 608 via a standard protocol (e.g., SMTP), that enables communication across a routing version boundary. The “Version B” transport servers 608 are in turn in communication with “Version B” mailbox servers 610, which send and receive messages of a “Version B” client 612. The “Version A” client 602 and the “Version B” client 612 can be client devices that operate with the message application programming interface (MAPI) architecture, for example.

In an example operation, the “Version A” client 602 sends a message to one of the “Version A” mailbox servers 604 (e.g., a “Version A” mailbox server 614), which submits the message to one of the “Version A” transport servers 606 (e.g., a “Version A” transport server 616) from the available pool in the same “Version A” network segment. If multiple servers are available, the “Version A” transport server 616 can be selected according to a round robin basis, for example, or other suitable selection method. If none of the “Version A” transport servers 606 are available, then the message will remain on the “Version A” mailbox server 614. In one implementation, information related to this event can be logged as a record for later analysis. The “Version A” mailbox servers 604 cannot select a “Version B” transport server to submit the message even if a “Version B” transport server is available.

Similarly, the “Version B” client 612 can submit a message to the “Version A” client 602, for example, via one of the “Version B” mailbox servers 610 (e.g., “Version B” mailbox server 618). The “Version B” mailbox server 618 submits the message to one of the “Version B” transport servers 608 (e.g., “Version B” transport server 620) in the same network segment (Version B). The “Version B” mailbox server 618 selects the “Version B” transport server 620 of the “Version B” transport servers 608 from an available pool. If multiple servers are available, the “Version B” transport server 620 can be selected on a round robin basis, for example. If no “Version B” transport server is available, then the message remains on the “Version B” mailbox server 618.

Continuing with the initial example of sending the message from the “Version A” client 602 to the “Version B” client 612, the “Version A” transport server 616 resolves the recipient (“Version B” client 612) of the message to a mailbox (e.g., “Version B” mailbox server 618) in the same site, where the site is defined to include the “Version A” client, servers, and transports, as well as the “Version B” clients, servers, and transports.

The “Version A” transport server 616 compares the version number of the “Version B” mailbox server 618 associated with the recipient (“Version B” client 612) to the version numbers of the “Version A” transport server 616. If the version of the “Version B” mailbox server 618 matches the server version number of the “Version A” transport server 616, the “Version A” transport server 616 can deliver directly to the mailbox of the recipient in the “Version B” mailbox server 618 of the “Version B” network segment.

In the present scenario, however, the version numbers are not the same so the “Version A” transport server 616 delivers the message to a selected one (e.g., “Version B” transport server 620) of the “Version B” transport servers 608 which matches the version number of the “Version B” client 612. In order to make the selection, the “Version A” transport server 616 queries the available “Version B” transport servers 608 in the “Version B” network segment. If multiple servers are available, a server (e.g., “Version B” transport server 620) can be selected according to a desired selection method (e.g., a round robin basis). The “Version A” transport server 616 then routes the message to the “Version B” transport server 620.

If there is no transport server having a version number that matches the version number of the “Version B” client 612, then the message queues in the “Version A” transport server 616.

The “Version B” transport server 620 resolves the “Version B” client 612 of the message to a mailbox on one (e.g., “Version B” mailbox server 618) of the same-site “Version B” mailbox servers 610. The “Version B” transport server 620 then delivers the message to the “Version B” mailbox server 618.

In a reverse operation of the “Version B” client 612 sending a message to the “Version A” client 602, the description is the same as above by replacing the Version A entities with the Version B entities.

Note that although described in the context of version based routing, the above examples and scenarios apply to capabilities and/or features based routing as well.

In the implementation of FIG. 6, inter-site routing can remain unchanged between versions. Routing between different network segments involves communication between transport servers. Alternatively, a system can implement capabilities-based routing across site boundaries. There are no inter-version delivery issues between the “Version A” transport servers 606 and the “Version B” transport servers 608. The clients can be user mailboxes, public folders, etc. When a client posts a message for access, the same routing behavior is used as described hereinabove. The transport servers can compare the version number of the message against the version number of a public folder database.

Different server versions, capabilities, features, and/or message requirements can coexist on the same network by modifying the routing logic to do versioned routing. In this way, a mailbox server only submits messages to a transport server of the same version or capabilities. The message is not submitted if such a transport server is not found in the local network segment. A transport server only delivers the message directly to a mailbox server of the same version, capabilities, and/or features. If the versions are different, the transport server will deliver to another transport server in the local network segment that is of the same version as the target mailbox. If the transport server does try to deliver to an incompatible mailbox, the mailbox server will reject the message and the transport server can address this situation by deferring the message until the transport servers routing tables are reconciled. In other words, a network segment with a mailbox utilizes a transport server of the same version for messages to be deliverable to that mailbox.

Included herein is a set of flow charts representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

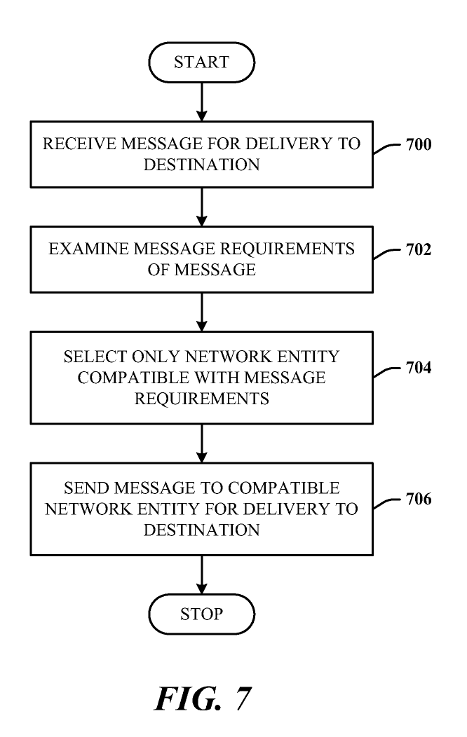

FIG. 7 illustrates a method of message requirements based message routing. At 700, a message is received for delivery to a destination. At 702, message requirements of the message are examined. At 704, only a network entity compatible with the message requirements is selected. At 706, the message is sent to the compatible network entity for delivery to the destination.

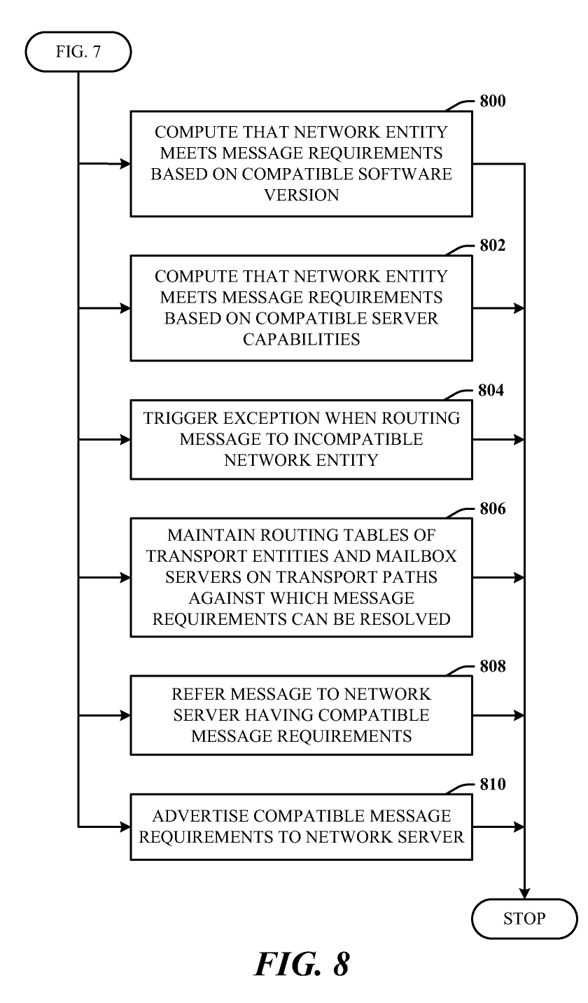

FIG. 8 illustrates additional aspects of the method of FIG. 7. At 800, it is computed that the network entity meets the message requirements based on a compatible software version. At 802, it is computed that the network entity meets the message requirements based on compatible server capabilities. At 804, an exception is triggered when routing the message to an incompatible network entity. At 806, routing tables are maintained of transport entities and mailbox servers on transport paths against which the message requirements can be resolved. At 808, the message is referred to a network server having compatible message requirements. At 810, compatible message requirements are advertised to a network server.

As described herein, the disclosed architecture can employ capabilities-based routing for messaging technologies such as email. Capabilities-based routing can be extended to other messaging technologies such as direct messages (e.g., instant messaging).

As used in this application, the terms “component” and “system” are intended to refer to a computer-related entity, either hardware, a combination of hardware and software, software, or software in execution. For example, a component can be, but is not limited to being, a process running on a processor, a processor, a hard disk drive, multiple storage drives (of optical, solid state, and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. The word “exemplary” may be used herein to mean serving as an example, instance, or illustration. Any aspect or design described herein as “exemplary” is not necessarily to be construed as preferred or advantageous over other aspects or designs.

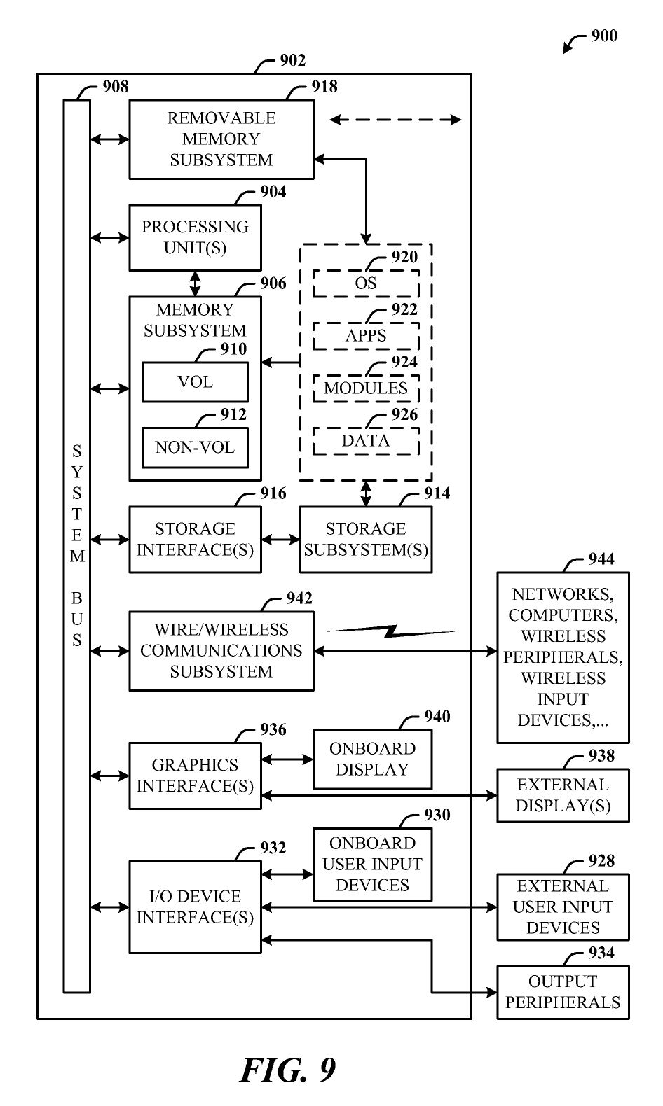

Referring now to FIG. 9, there is illustrated a block diagram of a computing system 900 operable to execute message routing in accordance with the disclosed architecture. In order to provide additional context for various aspects thereof, FIG. 9 and the following discussion are intended to provide a brief, general description of the suitable computing system 900 in which the various aspects can be implemented. While the description above is in the general context of computer-executable instructions that can run on one or more computers, those skilled in the art will recognize that a novel embodiment also can be implemented in combination with other program modules and/or as a combination of hardware and software.

The computing system 900 for implementing various aspects includes the computer 902 having processing unit(s) 904, a system memory 906, and a system bus 908. The processing unit(s) 904 can be any of various commercially available processors such as single-processor, multi-processor, single-core units and multi-core units. Moreover, those skilled in the art will appreciate that the novel methods can be practiced with other computer system configurations, including minicomputers, mainframe computers, as well as personal computers (e.g., desktop, laptop, etc.), hand-held computing devices, microprocessor-based or programmable consumer electronics, and the like, each of which can be operatively coupled to one or more associated devices.

The system memory 906 can include volatile (VOL) memory 910 (e.g., random access memory (RAM)) and non-volatile memory (NON-VOL) 912 (e.g., ROM, EPROM, EEPROM, etc.). A basic input/output system (BIOS) can be stored in the non-volatile memory 912, and includes the basic routines that facilitate the communication of data and signals between components within the computer 902, such as during startup. The volatile memory 910 can also include a high-speed RAM such as static RAM for caching data.

The system bus 908 provides an interface for system components including, but not limited to, the memory subsystem 906 to the processing unit(s) 904. The system bus 908 can be any of several types of bus structure that can further interconnect to a memory bus (with or without a memory controller), and a peripheral bus (e.g., PCI, PCIe, AGP, LPC, etc.), using any of a variety of commercially available bus architectures.

The computer 902 further includes storage subsystem(s) 914 and storage interface(s) 916 for interfacing the storage subsystem(s) 914 to the system bus 908 and other desired computer components. The storage subsystem(s) 914 can include one or more of a hard disk drive (HDD), a magnetic floppy disk drive (FDD), and/or optical disk storage drive (e.g., a CD-ROM drive DVD drive), for example. The storage interface(s) 916 can include interface technologies such as EIDE, ATA, SATA, and IEEE 1394, for example.

One or more programs and data can be stored in the memory subsystem 906, a removable memory subsystem 918 (e.g., flash drive form factor technology), and/or the storage subsystem(s) 914 (e.g., optical, magnetic, solid state), including an operating system 920, one or more application programs 922, other program modules 924, and program data 926.

Generally, programs include routines, methods, data structures, other software components, etc., that perform particular tasks or implement particular abstract data types. All or portions of the operating system 920, applications 922, modules 924, and/or data 926 can also be cached in memory such as the volatile memory 910, for example. It is to be appreciated that the disclosed architecture can be implemented with various commercially available operating systems or combinations of operating systems (e.g., as virtual machines).

The aforementioned application programs 922, program modules 924, and program data 926 can include the computer-implemented system 100 of FIG. 1 such as the input component 102, the transport server 104, the message 106, the destination 108, the message requirements 110, and the routing component 112, the operational features 200, the server version information 202, and the server capabilities information 204 of FIG. 2, the system 300 of FIG. 3, including further additional components such as the storage component 302, the routing information 304, the referral component 306, the compatible server 308, the advertising component 310, and the compatible network components 312, for example.

The aforementioned application programs 922, program modules 924, and program data 926 can also include the system 400 of FIG. 4, the system 500 of FIG. 5, including further additional components such as the routing tables 502, the exception handling component 504, the lookup component 506, and the compatible network transport entities 508, the network implementation 600 of FIG. 6, including further additional components such as the “Version A” client 602, the “Version A” mailbox servers 604, the “Version A” transport servers 606, the “Version B” transport servers 608, the “Version B” mailbox servers 610, and the “Version B” client 612, and the methods and aspects of FIGS. 7-8, for example.

The storage subsystem(s) 914 and memory subsystems (906 and 918) serve as computer readable media for volatile and non-volatile storage of data, data structures, computer-executable instructions, and so forth. Computer readable media can be any available media that can be accessed by the computer 902 and includes volatile and non-volatile media, removable and non-removable media. For the computer 902, the media accommodate the storage of data in any suitable digital format. It should be appreciated by those skilled in the art that other types of computer readable media can be employed such as zip drives, magnetic tape, flash memory cards, cartridges, and the like, for storing computer executable instructions for performing the novel methods of the disclosed architecture.

A user can interact with the computer 902, programs, and data using external user input devices 928 such as a keyboard and a mouse. Other external user input devices 928 can include a microphone, an IR (infrared) remote control, a joystick, a game pad, camera recognition systems, a stylus pen, touch screen, gesture systems (e.g., eye movement, head movement, etc.), and/or the like. The user can interact with the computer 902, programs, and data using onboard user input devices 930 such a touchpad, microphone, keyboard, etc., where the computer 902 is a portable computer, for example. These and other input devices are connected to the processing unit(s) 904 through input/output (I/O) device interface(s) 932 via the system bus 908, but can be connected by other interfaces such as a parallel port, IEEE 1394 serial port, a game port, a USB port, an IR interface, etc. The I/O device interface(s) 932 also facilitate the use of output peripherals 934 such as printers, audio devices, camera devices, and so on, such as a sound card and/or onboard audio processing capability.

One or more graphics interface(s) 936 (also commonly referred to as a graphics processing unit (GPU)) provide graphics and video signals between the computer 902 and external display(s) 938 (e.g., LCD, plasma) and/or onboard displays 940 (e.g., for portable computer). The graphics interface(s) 936 can also be manufactured as part of the computer system board.

The computer 902 can operate in a networked environment (e.g., IP) using logical connections via a wired/wireless communications subsystem 942 to one or more networks and/or other computers. The other computers can include workstations, servers, routers, personal computers, microprocessor-based entertainment appliance, a peer device or other common network node, and typically include many or all of the elements described relative to the computer 902. The logical connections can include wired/wireless connectivity to a local area network (LAN), a wide area network (WAN), hotspot, and so on. LAN and WAN networking environments are commonplace in offices and companies and facilitate enterprise-wide computer networks, such as intranets, all of which may connect to a global communications network such as the Internet.

When used in a networking environment the computer 902 connects to the network via a wired/wireless communication subsystem 942 (e.g., a network interface adapter, onboard transceiver subsystem, etc.) to communicate with wired/wireless networks, wired/wireless printers, wired/wireless input devices 944, and so on. The computer 902 can include a modem or has other means for establishing communications over the network. In a networked environment, programs and data relative to the computer 902 can be stored in the remote memory/storage device, as is associated with a distributed system. It will be appreciated that the network connections shown are exemplary and other means of establishing a communications link between the computers can be used.

The computer 902 is operable to communicate with wired/wireless devices or entities using the radio technologies such as the IEEE 802.xx family of standards, such as wireless devices operatively disposed in wireless communication (e.g., IEEE 802.11 over-the-air modulation techniques) with, for example, a printer, scanner, desktop and/or portable computer, personal digital assistant (PDA), communications satellite, any piece of equipment or location associated with a wirelessly detectable tag (e.g., a kiosk, news stand, restroom), and telephone. This includes at least Wi-Fi (or Wireless Fidelity) for hotspots, WiMax, and Bluetooth™ wireless technologies. Thus, the communications can be a predefined structure as with a conventional network or simply an ad hoc communication between at least two devices. Wi-Fi networks use radio technologies called IEEE 802.11x (a, b, g, etc.) to provide secure, reliable, fast wireless connectivity. A Wi-Fi network can be used to connect computers to each other, to the Internet, and to wire networks (which use IEEE 802.3-related media and functions).

The illustrated aspects can also be practiced in distributed computing environments where certain tasks are performed by remote processing devices that are linked through a communications network. In a distributed computing environment, program modules can be located in local and/or remote storage and/or memory system.

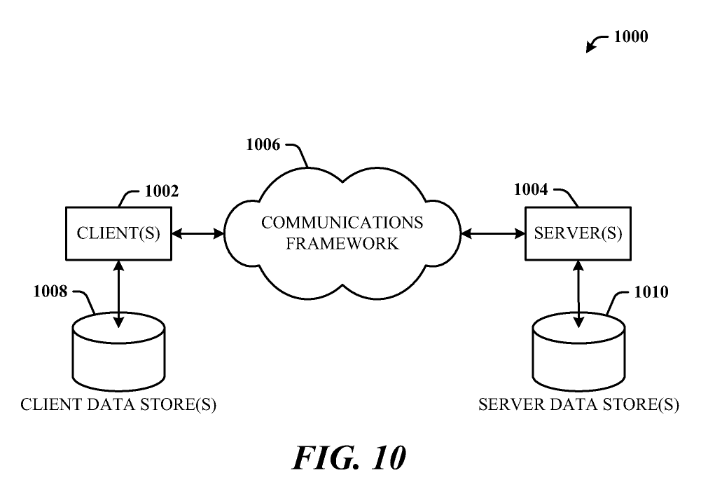

Referring now to FIG. 10, there is illustrated a schematic block diagram of a computing environment 1000 operable to provide message routing according to message requirements. The environment 1000 includes one or more client(s) 1002. The client(s) 1002 can be hardware and/or software (e.g., threads, processes, computing devices). The client(s) 1002 can house cookie(s) and/or associated contextual information, for example.

The environment 1000 also includes one or more server(s) 1004. The server(s) 1004 can also be hardware and/or software (e.g., threads, processes, computing devices). The servers 1004 can house threads to perform transformations by employing the architecture, for example. One possible communication between a client 1002 and a server 1004 can be in the form of a data packet adapted to be transmitted between two or more computer processes. The data packet may include a cookie and/or associated contextual information, for example. The environment 1000 includes a communication framework 1006 (e.g., a global communication network such as the Internet) that can be employed to facilitate communications between the client(s) 1002 and the server(s) 1004.

Communications can be facilitated via a wire (including optical fiber) and/or wireless technology. The client(s) 1002 are operatively connected to one or more client data store(s) 1008 that can be employed to store information local to the client(s) 1002 (e.g., cookie(s) and/or associated contextual information). Similarly, the server(s) 1004 are operatively connected to one or more server data store(s) 1010 that can be employed to store information local to the servers 1004.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A computer-implemented message system, comprising:
an input component of a transport server for receiving a message for delivery to a compatible destination, the message having message requirements that designate delivery over a compatible transport path; and
a routing component of the transport server for routing the message over the compatible transport path to the destination according to the message requirements.

2. The system of claim 1, wherein the message requirements include operational features, the message routed over a transport path having compatible operational features.

3. The system of claim 1, wherein the message requirements include server version information, the message routed over a transport path having compatible server versions.

4. The system of claim 1, wherein the message requirements include server capabilities information, the message routed over a transport path having compatible server capabilities.

5. The system of claim 1, further comprising a storage component for maintaining routing information related to transport servers via which the message can be routed.

6. The system of claim 1, further comprising a referral component for referring the message to a compatible server associated with the message requirements.

7. The system of claim 1, further comprising an advertising component for advertising the message requirements to compatible network components.

8. A computer-implemented message system, comprising:
an input component for receiving a message for delivery to a destination, the message having message requirements that designate delivery over a transport path compatible with the message requirements;
a storage component for maintaining routing information related to a network transport entity compatible with the message requirements and via which the message can be routed; and
a routing component for routing the message to the compatible network transport entity for delivery to the destination while avoiding delivery to network transport entities incompatible with the message requirements.

9. The system of claim 8, wherein the message requirements are version information, the message routes only to the compatible network transport entity having the same version information.

10. The system of claim 8, wherein the message requirements relate to software features, the message routed only to network entities having the same software features.

11. The system of claim 8, further comprising routing tables for maintaining message routes along server paths operating with respective compatible message requirements.

12. The system of claim 8, further comprising an exception handling component for routing the message to a different compatible network transport entity in the event of delivery of the message to an incompatible network transport entity.

13. The system of claim 8, further comprising a lookup component of the input component to locate available compatible network transport entities through which the message can be routed.

14. A computer-implemented messaging method, comprising:
receiving a message for delivery to a destination;
examining message requirements of the message;
selecting only a network entity compatible with the message requirements; and
sending the message to the compatible network entity for delivery to the destination.

15. The method of claim 14, further comprising computing that the network entity meets the message requirements based on a compatible software version.

16. The method of claim 14, further comprising computing that the network entity meets the message requirements based on compatible server capabilities.

17. The method of claim 14, further comprising triggering an exception when routing the message to an incompatible network entity.

18. The method of claim 14, further comprising maintaining routing tables of transport entities and mailbox servers on transport paths against which the message requirements can be resolved.

19. The method of claim 14, further comprising referring the message to a network server having compatible message requirements.

20. The method of claim 14, further comprising advertising compatible message requirements to a network server.
